(19) United States
(12) Patent Application Publication
(10) Pub. No.: US 2015/0016653 A1
(43) Pub. Date: Jan. 15, 2015

(54) TUNABLE HEADPHONE

(71) Applicant: Dexin Corporation, New Taipei City (TW)

(72) Inventor: TUNG-KO LU, NEW TAIPEI CITY (TW)

(21) Appl. No.: 13/941,602

(22) Filed: Jul. 15, 2013

(51) Int. Cl. H04R 1/10

(52) U.S. Cl. CPC H04R 1/1066
USPC 381/379

(57) ABSTRACT

A tuning headphone is adapted to engage to the user's ear. The tuning headphone includes a perforated frame, a tuning frame and an acoustic generator. The perforated frame comprises a frame annular portion and a frame flat surface. The frame flat surface is arranged at a distal end of the frame annular portion away from the user's ear, and has portions defining at least one frame opening. A surface of the frame annular portion proximate to the user's ear is a curved inner face. The tuning frame has portions defining at least one opening and rotatably covers an end of the perforated frame distal from the user's ear, thereby providing adjustability to the air communicable area between the opening and the frame opening. Moreover, the acoustic generator is configured at a proximal end of the frame annular portion near the user's ear.

### BACKGROUND OF THE INVENTION

1. Field of the Invention

The instant disclosure relates to a tunable headphone.

2. Description of Related Art

Headphones are common accessories for listening to the music, as well as a suitable tool for not disturbing people in the surrounding. Since headphones are typically portable accessories, portable headphones are small in size and lightweight.

However, the conventional casing of the conventional headphone forms a closed space and the sound output is limited by the volume of the closed space, which influences the properties of the output sound. Moreover, if the volume of the headphone is small, the resonance generated is correspondingly small such that the preferred bass tone is relatively difficult to reproduce. Furthermore, since people use headphones in all sorts of conditions and environments such as during music listening, conversation, gaming, etc, different sounds should be provided at various conditions. As a result, parameters are changed at various conditions. However, the conventional headphones do not provide users to change the required parameters.

To address the above issues, the inventor strives via associated experience and research to present the instant disclosure, which can effectively improve the limitation described above.

### SUMMARY OF THE INVENTION

The object of the instant disclosure is to provide a tunable headphone.

In order to achieve the aforementioned objects, according to an embodiment of the instant disclosure, a tuning headphone is adapted to engage to the user's ear. The tuning headphone includes a perforated frame, a tuning frame and an acoustic generator. The perforated frame comprises a frame annular portion and a frame flat surface. The frame flat surface is arranged at an end of the frame annular portion distal from the user's ear, and has portions defining at least one frame opening. The frame annular portion has a curved inner face. The tuning frame has portions defining at least one opening and rotatably covers an end of the perforated frame distal from the user's ear, thereby providing adjustability to the overlapping between the air communicable opening and frame opening. Moreover, the acoustic generator is configured at a proximal end of the frame annular portion near the user's ear.

The instant disclosure provides the following improvement. The tuning frame is rotatably disposed on the perforated frame such that users can select the preferred sound performance of the tunable headphone based on the environment in which the headphone is used.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1 is a cross-sectional view of a tunable headphone in accordance with the instant disclosure;

FIG. 2 is an exploded view of the tunable headphone in accordance with the instant disclosure;

FIG. 3 is another exploded view of the tunable headphone in accordance with the instant disclosure;

FIG. 4 is a schematic diagram illustrating an operational state of the tunable headphone in accordance with the instant disclosure;

FIG. 5 is a schematic diagram illustrating another operational state of the tunable headphone in accordance with the instant disclosure;

FIG. 6 is a schematic diagram illustrating another operational state of the tunable headphone in accordance with the instant disclosure;

FIG. 7 is a schematic diagram illustrating the appearance of the tunable headphone in accordance with the instant disclosure;

FIG. 8 is a graph illustrating the impedance of the tunable headphone in accordance with the instant disclosure; and

FIG. 9 is a graph illustrating the impedance of the tunable headphone in accordance with another embodiment of the instant disclosure.

### DETAILED DESCRIPTION OF THE PREFERRED EMBODIMENTS

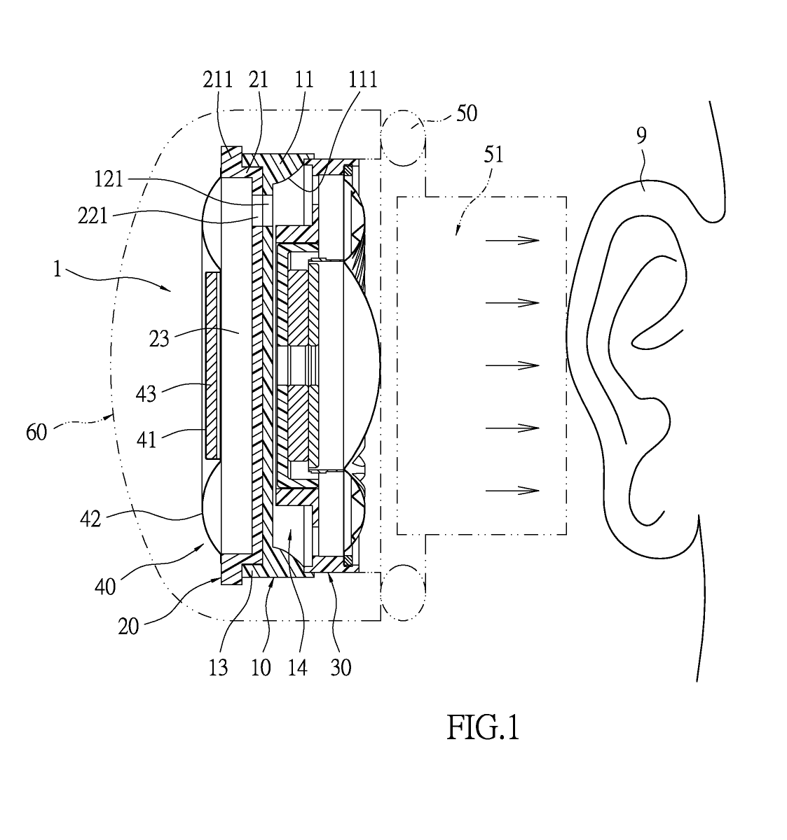

As shown in FIG. 1, the instant disclosure provides a tunable headphone 1, adapted to engage a user's ear 9, comprises a perforated frame 10, a tuning frame 20, an acoustic generator 30, and an elastic member 50. The acoustic generator 30 is configured at a proximal end of the perforated frame 10 near the user's ear 9, the tuning frame 20 can rotatably cover an end of the perforated frame 10 distal from the user's ear 9, and the elastic member 50 is configured at a proximal end of the acoustic generator 30 near the user's ear 9. When the tunable headphone 1 is adapted to engage the user's ear 9, the elastic member 50, the acoustic generator 30, and the user's ear 9 cooperatively forms a front chamber therebetween.

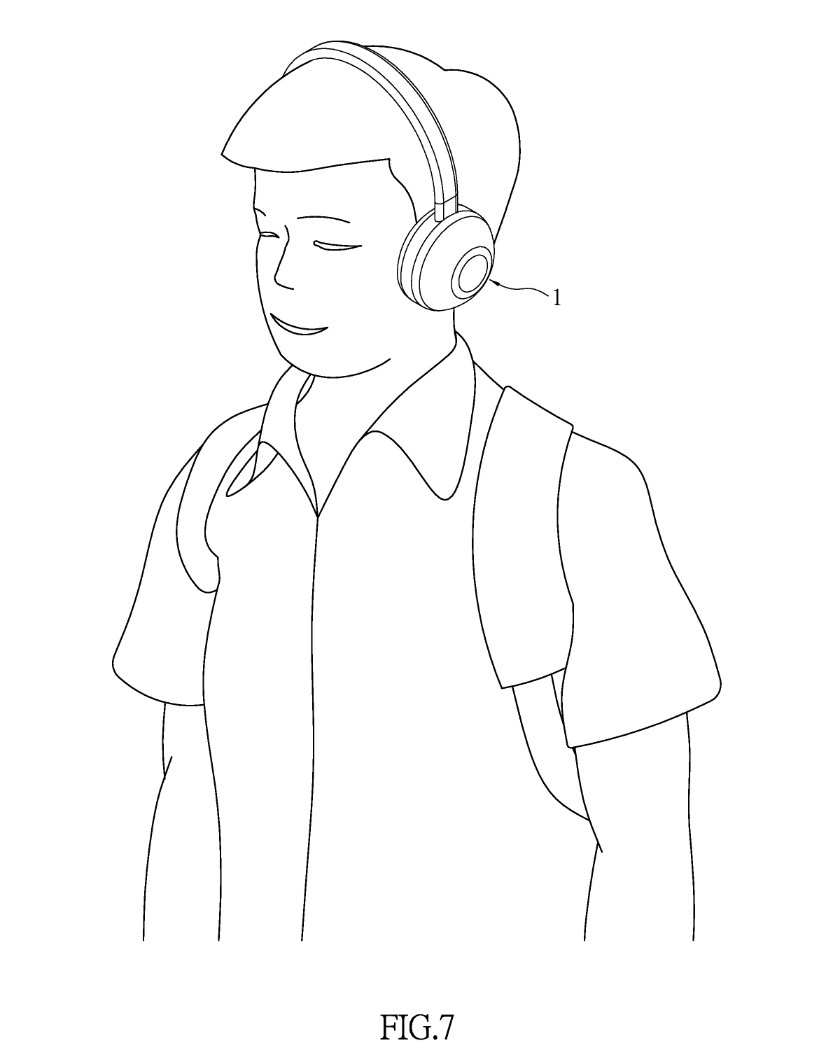

The acoustic generator 30 can be driven by dynamic, static, balanced armature, or various types of mechanisms depending on the overall preference of the headphone 1, and the overall preference is based on any or any combination of the following factors such as cost, frequency, sensitivity requirement, sound quality, and usable life. The elastic member 50 may be substantially high density foam ear pads, silicon earplugs, or foam ear plugs. When the elastic member 50 is in use, a proximal end is adapted to engage the user's ear to improve the airtightness between the tunable headphone 1 and the user's ear, as well as comfort of the user. The choice of the elastic member 50 depends on the position thereof relatively to the user's ear. For example, if the elastic member 50 is disposed in the user's ear, the tunable headphone 2 is an in-ear type headphones, thus, earplug or any similar types of headphones is selected as the elastic member 50. The elastic member 50 of the instant embodiment is adapted to engage the pinna of the user's ear. In other words, the tunable headphone 1 is for example (as shown in FIG. 7) a circumaural headphone and as such, the elastic member 50 is for example an ear pad.

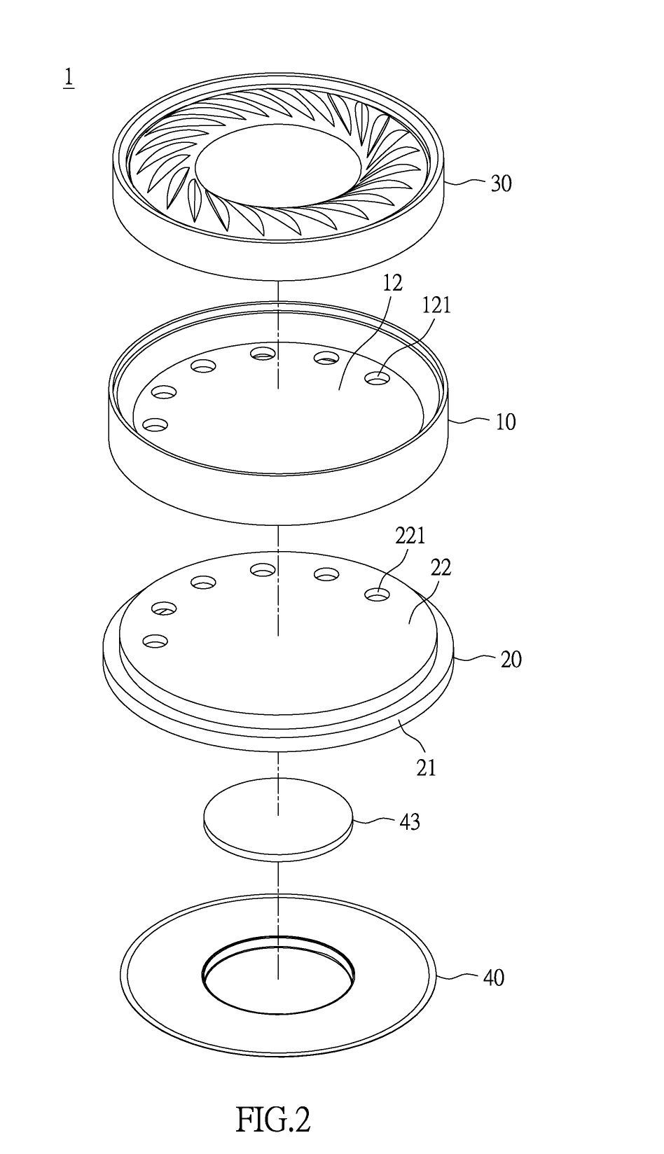

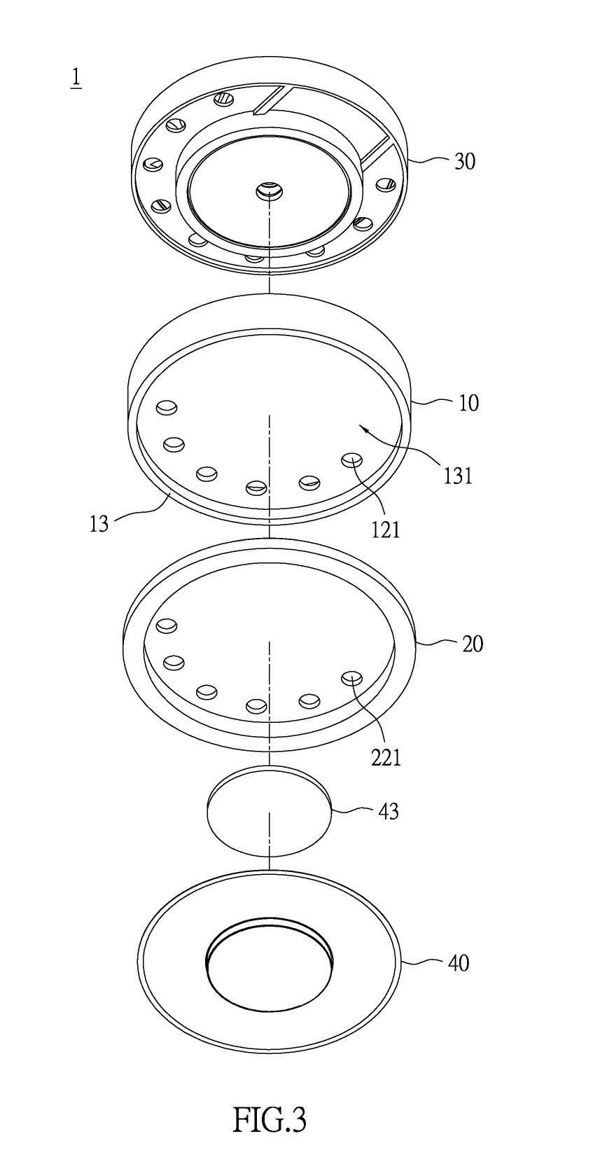

As illustrated in FIGS. 1, 2, and 3, the perforated frame 10 includes a frame annular portion 11, a frame flat surface 12, and a sidewall 13. The frame flat surface 12 has portions defining at least one frame opening 121. Six frame openings are chosen as an example in the instant embodiment. However, the number of frame openings is not limited herein. The frame flat surface 12 is configured at an end of the frame annular portion 11 distal from the user's ear 9 such that the end is substantially sealed. The frame annular portion 11 has a curved inner face 111 and the curved inner face 111 is reducing towards a center of the frame annular portion 11 and a direction towards the ear canal. The structure as aforementioned configures to provide smooth airflow passing through the curved inner face 111. The air passing through the curved inner face is correspondingly compressed such that sound frequency changes. The sidewall 13 is formed as an extension from the frame flat surface 12 and extends towards a direction away from the user's ear 9. The sidewall 13 and the frame flat surface 12 cooperatively form a recess 131. The frame annular portion 11, the frame flat surface 12, and the sidewall 13 are integrally formed.

The tuning frame 20 includes an annular portion 21 and a flat surface 22. The flat surface 22 has portions defining at least one opening 221. The cross-sectional area and the number of opening 221 equals to the cross-sectional area and the number of frame openings 121. The flat surface 22 is arranged on a proximal end of the annular portion 21 of the tuning frame 20. A distal end of the annular portion 21 away from the user's ear 9 has a tuning portion 211 extending outwardly along an outer diameter thereof. The annular portion 21 of the tuning frame 20, the flat surface 22, and the tuning portion 211 are integrally formed.

Further disclosure of the assembly of the perforated frame 10, the tuning frame 20, and the acoustic generator 30 are provided below. The acoustic generator 30 is configured at a proximal end of the frame annular portion 11 of the perforated frame 10 near the user's ear 9, such that the perforated frame 10 and the acoustic generator 30 cooperatively forms a rear chamber 14. The flat surface 22 of the tuning frame 20 and the frame flat surface 12 of the perforated frame 10 are evenly abutted. The annular portion 21 of the tuning frame 20 has an outer diameter, and the outer diameter is substantially equivalent to an inner diameter of the sidewall 13 of the perforated frame 10. Thus, the annular portion 21 and the flat surface 22 are conformingly fitted in the recess 131. The tuning portion 211 is pressed against a distant end of the sidewall 13 away from the user's ear 9. The tuning portion 211 has an outer diameter larger than an outer diameter of the sidewall 13 such that the user can directly or indirectly rotate the tuning frame 20 via the tuning portion 211 with ease. In other words, the user can directly rotate the tuning portion 211 of the tuning frame 20 with fingers. The tuning portion 211 can also be rotated by further configuring the instant embodiment with decorative covers and gears (both not shown in figures).

When the acoustic generator 30 generates vibration which in turn generates sound, the air pressure in the front chamber 51 and the rear chamber 14 changes. Since the elastic member 50 and the user's ear 9 cooperatively define the front chamber 51, with different shapes and sizes of ears 9, the size of the front chamber 51 varies. In terms of acoustic cavities, the front chamber 51 provides high frequency resonance. If the front chamber leaks in any way or has openings, the low frequency attenuates. Since the rear chamber 14 is defined by the perforated frame 10, the volume of the rear chamber 14 remains substantially constant. In terms of acoustic cavities, the rear chamber 14 provides low frequency resonance. However, the fully closed rear chamber 14 significantly dampens the acoustic generator 30. Via the frame openings 121, the rear chamber is air communicable with the atmosphere, and thus, the rear chamber 14 dampens the acoustic generator 30 relatively less.

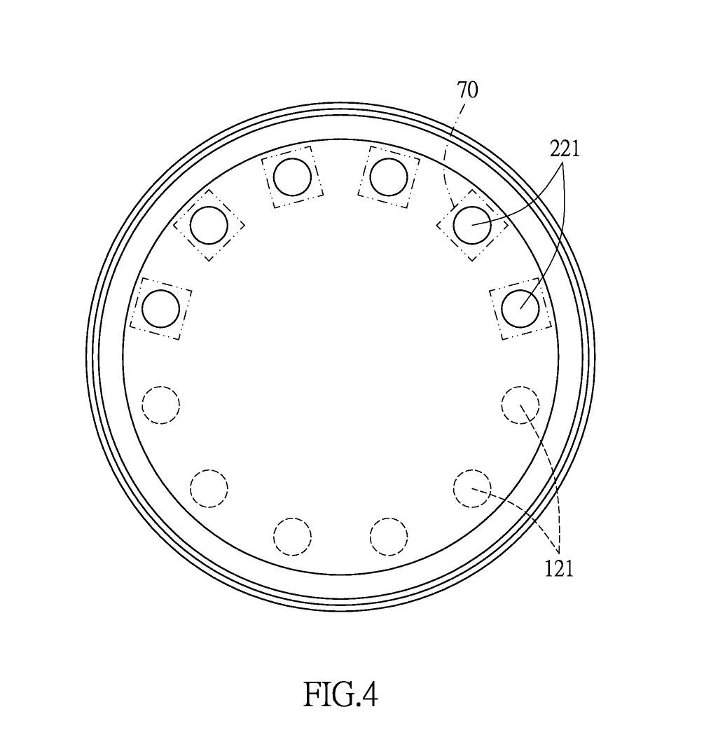

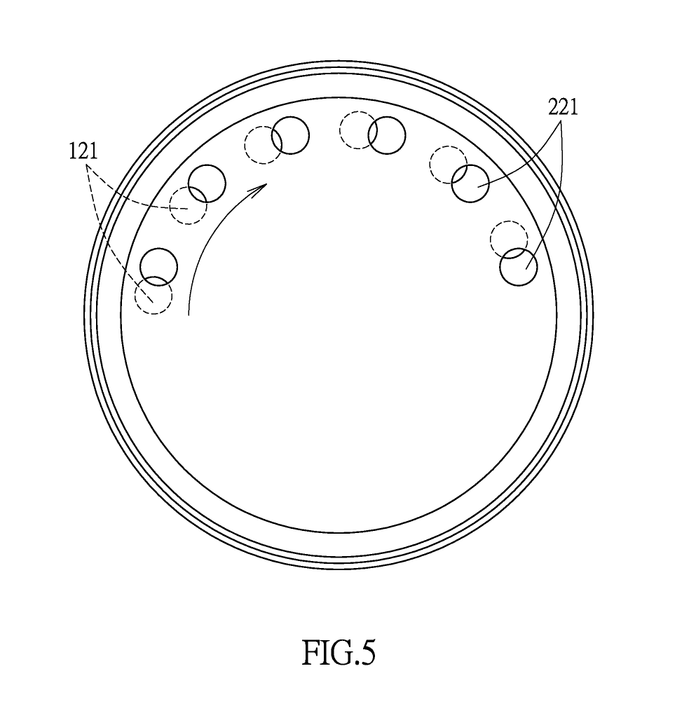

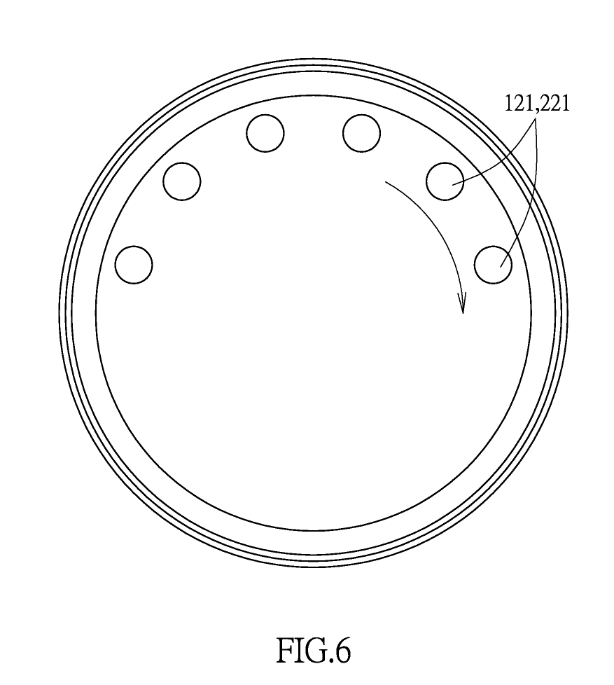

As shown in FIGS. 4, 5, and 6, the tuning frame 20 can mutually rotate with respect to the perforated frame 10, such that the user can adjust the degree of overlapping between the frame openings 121 and the opening 221. As illustrated in FIG. 4, all the frame openings 121 are covered. In other words, the frame openings 121 and the openings 221 are not overlapping, which will be further described. As shown in FIG. 5, the frame openings 121 are partially covered by the flat surface 22, and the openings 221 and the frame openings 121 are partially overlapping with each other. As shown in FIG. 6, the openings 221 and the frame openings 121 are completely overlapping with each other.

Through the tuning frame 20, the degree of overlapping can be adjusted between the frame openings 121 and the openings 221, such that the user can adjust the dampening effect of the rear chamber 14 to the acoustic generator 30 and the minimum resonance frequency f₀. Thus, the impedance curve of the tunable headphone can be adjusted.

The following description explains the minimum resonance frequency f₀ and the quality factor Q (also known as resonance point). The minimum resonance frequency f₀ represents the first maximum frequency on the impedance curve of the speakers. When a sound frequency is close to the minimum resonance frequency f₀, the vibration is relatively strong, and thus, frequencies near the minimum resonance frequency f₀ are the more preferred sound effect performance. Q represents the suppressing ability of acoustic vibrations of the acoustic generator 30. In other words, Q can reflect the dampening state of the acoustic generator 30. When the value of Q is excessively low, the sound pressure outputted by the acoustic generator 30 has not yet rapidly reduced, and the acoustic generator 30 is dampened, which renders the low frequencies to over-attenuate. When the value of Q is excessively high, the acoustic generator 30 is under-dampened, which renders the low frequencies excessively enhanced. In terms of audio, when the value of Q is relatively low, the bass tone emitted is short yet has a sustaining tone. In other words, the sound cannot be continuous. When the value of Q is relatively high, the base tone emitted is relatively deeper; however the sound is more continuous. As a result, the minimum resonance frequency f₀ and Q are correspondingly adjusted depending on the preference of the user and the type of sound preferably played. Depending on the surrounding conditions (for example: during chatting, gaming, or just music listening), the user can adjust the minimum resonance frequency f₀ and Q of the tunable headphone 1 to provide the most preferred sound effects. Characteristics of various modes are provided in a later section.

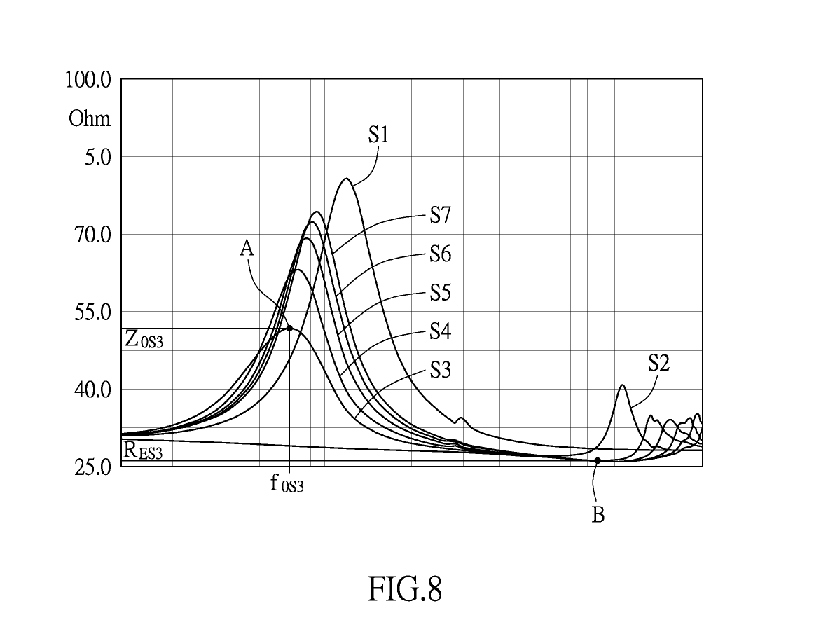

FIG. 8 is an experimental graph illustrating impedance of the tunable headphone 1 under various states as a function of frequency. Si represents the impedance curve when the acoustic generator 30 is in direct air communication with the atmosphere, and S2 to S7 represents the impedance curves when the acoustic generator 30 is in the perforated frame 10. In particular, S2 represents the state of complete absence of overlapping between any of the openings 221 and any of the frame openings 121. S3 represents the state of one opening 221 and one frame opening 121 overlapping. S4 represents the state of two openings 221 and two frame openings 121 overlapping. S5 represents the state of three openings 221 and three frame openings 121 overlapping. S6 represents the state of four openings 221 and four frame openings 121 overlapping. S7 represents the state of five openings 221 and five frame openings 121 overlapping. The value of Q is determined by the following equation:

$$Q = \sqrt{\frac{{R}_{E}}{{Z}_{O}}} \cdot \frac{{f}_{o}}{{f}_{2} - {f}_{1}} \qquad ( 1 )$$

R₁=\sqrt{Z_{O}·R_{E}} (2)

where f₀ as the minimum resonance frequency, R_{E} as the minimum impedance at a corresponding frequency which is larger than the minimum resonance frequency (f₀), Z₀ as the impedance at the minimum resonance frequency (f₀), and f₂−f₁ as the frequency difference at an impedance of R₁, which is bandwidth. Take the curve S3 in FIG. 8 for example. The frequency corresponding to the highest point A on S3 is f₀ ( f_{0S3} as labeled on the graph), while the impedance corresponding to the highest point A on S3 is Z₀ (Z_{0S3} as labeled on the graph), and the impedance corresponding to the lowest point B on the curve S3 is R_{E} (R_{ES3} as labeled on the graph). From the description above, the value of R₁ is determined, and thus, the value of the bandwidth (f₂−f₁).

Based on FIG. 8 and the equation of Q, when the acoustic generator 30 is installed in the perforated frame 10 and the tuning frame 20, the values of f₀ and Q changes. As the number of opening 221 and the frame opening 121 changes, the values of f₀ and Q also changes. In general, when the value of f₀ is reduced, the value of Q also reduces.

As aforementioned, depending on the overlapping state between the number of openings 221 and frame openings 121, the values of f₀ and Q correspondingly changes. As a result, with the configuration of the perforated frame 10 and the tuning frame 10, the tunable headphone 1 of the instant disclosure provides users the freedom to select the preferred values of f₀ and Q in order to achieve the most preferred sound effects.

In another embodiment of the instant disclosure, the tunable headphone 1 further comprises a passive diaphragm 40. The passive diaphragm 40 is made of elastic materials. The passive diaphragm 40 seals an end of the tuning frame 20 distal from the user's ear 9. The passive diaphragm 40 has a center protrusion 41 and an annular protrusion 42 arranged thereon while both protrusions 41, 42 point away from the direction of the user's ear 9. The annular protrusion 42 is arranged around the center protrusion 41. With the configuration of the center protrusion 41 and the annular protrusion 42, the passive diaphragm 40 is relatively more flexible. The passive diaphragm 40 also has a weight member 43 configured thereat such that the overall weight of the passive diaphragm 40 can be adjusted.

The passive diaphragm 40 seals the distal end of the tuning frame 20 away from the user's ear 9 such that the passive diaphragm 40 and the tuning frame 20 are configured to define a tuning chamber 23 therebetween. Since the passive diaphragm 40 is made of elastic materials, the tuning chamber 23 can slightly change in volume. When the frame openings 121 and the openings 221 are air communicable, the rear chamber 14 and the tuning chamber 23 are also air communicable. Since the tuning chamber 23 can slightly change in volume, the rear chamber 14 may have a relatively less dampening effect on the acoustic generator 30. Not only can the passive diaphragm 40 provides changes to the dampening of the acoustic generator 30 via the rear chamber 14, the rear chamber 14 and the tuning chamber 23 can also retain clean sounds similar to those characterized by sealing headphones and not easily be interfered by ambient noises from outside the headphone.

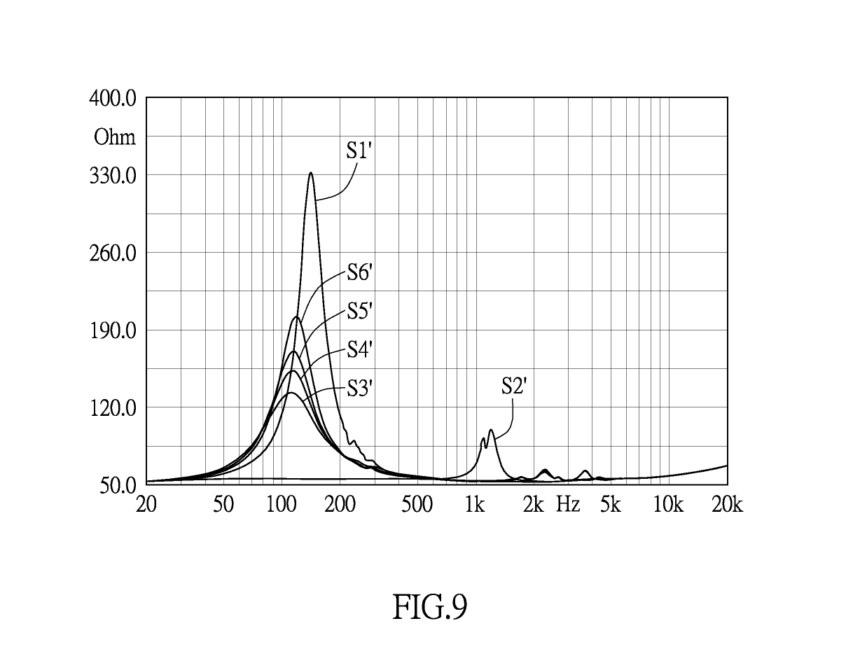

FIG. 9 is an impedance graph illustrating the tunable headphone 1 at various states when the tuning frame 20 has the passive diaphragm 40 arranged thereon. In FIG. 9, S1′ represents the impedance curve when the acoustic generator 30 is in direct air communication with the atmosphere, and S2′ to S6′ represents the impedance curves when the acoustic generator 30 is in the perforated frame 10, and the tuning frame 20 has the passive diaphragm 40 arranged thereon. In particular, S2′ represents the state of complete absence of overlapping between any of the openings 221 and any of the frame openings 121. S3′ represents the state of one opening 221 and one frame opening 121 overlapping. S4′ represents the state of two openings 221 and two frame openings 121 overlapping. S5′ represents the state of three openings 221 and three frame openings 121 overlapping. S6′ represents the state of four openings 221 and four frame openings 121 overlapping. As shown in FIG. 9, once the acoustic generator 30 is assembled with the perforated frame 10, the tuning frame 20, and the passive diaphragm 40, the f₀ and Q values of the impedance curves S2′ to S6′ change accordingly.

In another embodiment of the instant disclosure, the tunable headphone further comprises a tuning sheet 70. The tuning sheet 70 is a semi-air permeable material. The tuning sheet 70 seals an end of the openings 221 such that airflow flows through the frame openings 121, further through the openings 221, and then through the tuning sheet 70 to change the dampening of the acoustic generator 30 via the rear chamber 14. As a result, the values of the f₀ and Q of the tunable headphone 1 change.

The following description discloses the parametric states of various modes as aforementioned. Since the frequency of a human voice during conversation is about 500 to 6000 Hertz (Hz), the values of f0 and Q, at which the overlapping between any of the openings 221 and the frame openings 121 of the tunable headphone 1 is completely absent, are the most preferred values for a conversation mode. Whereas, the typical frequencies during gaming are substantially low, and the sounds are rather short and instant. As a result, the values of f₀ and Q, at which the overlapping between any of the openings 221 and the frame openings 121 of the tunable headphone 1 is one, are the most preferred values for a gaming mode. As for music, the frequencies for which are relatively low. As a result, the values of f₀ and Q, at which the overlapping between any of the openings 221 and the frame openings 121 of the tunable headphone 1 is five, are the most preferred values for a music listening mode. The aforementioned description of the overlapping between openings and frame openings are determined by the specification and the materials of the perforated frame 10, the tuning frame 20, the acoustic generator 30, and the passive diaphragm, but are not limited herein.

Please refer to FIGS. 1 and 7, in the instant embodiment of the instant disclosure, the tunable headphone 1 comprises a casing 60, the perforated frame 10, the tuning frame 20, and the acoustic generator 30 which is accommodated in the casing 60. The acoustic generator 30 is exposed through the casing 60 such that the acoustic generator 30 generates sounds towards the user's ear 9. The elastic member 50 is configured at a proximal end of the casing 60 near the user's ear 9 such that the tunable headphone 1 resembles a circumaural headphone.

The tunable headphone 1 of the instant disclosure improves upon the conventional arts in that through the corresponding configuration of the frame openings 121 and openings 221 respectively arranged on the perforated frame 10 and the tuning frame 20, the tuning frame 20 is rotatably disposed on the perforated frame 10 such that users can adjust the Q value via the corresponding effect of the rear chamber 14 to the acoustic generator 30 and select the preferred listening mode on the tunable headphone 1.

The figures and descriptions supra set forth illustrated the preferred embodiments of the instant disclosure; however, the characteristics of the instant disclosure are by no means restricted thereto. All changes, alternations, combinations or modifications conveniently considered by those skilled in the art are deemed to be encompassed within the scope of the instant disclosure delineated by the following claims.

What is claimed is:

1. A tunable headphone adapted to engage a user's ear, comprising:
a perforated frame having a frame annular portion and a frame flat surface, the frame flat surface arranged at an end of the frame annular portion distal from the user's ear, the frame flat surface having portions defining at least one frame opening, and (the frame annular portion having a curved inner face reducing toward the ear canal);
a tuning frame having portions defining at least one opening, the tuning frame rotatably covering an end of the perforated frame distal from the user's ear, thereby providing adjustability to the air communicable area between the opening and the frame opening; and
an acoustic generator configured at an end of the frame annular portion proximate to the user's ear.

2. The tunable headphone as recited in claim 1, wherein the curved inner face of the frame annular portion reduces towards a center of the frame annular portion.

3. The tunable headphone as recited in claim 1 further comprising:
a passive diaphragm configured at an end of the tuning frame distal from the user's ear.

4. The tunable headphone as recited in claim 3, wherein the passive diaphragm has a center protrusion and an annular protrusion, in which the annular protrusion is arranged around the center protrusion.

5. The tunable headphone as recited in claim 3, wherein the passive diaphragm has a weight member configured thereat.

6. The tunable headphone as recited in claim 1, wherein the frame flat surface has a sidewall extending from a peripheral edge thereof to a direction distal to the user's ear, the sidewall defines a recess, the tuning frame includes an annular portion and a flat surface, the flat surface has portions defining at least one opening, the tuning frame is received in the recess, and the flat surface evenly abuts the frame opening flat surface.

7. The tunable headphone as recited in claim 6, wherein the annular portion of the tuning frame has an end distal from the user's ear, the end has a tuning portion arranged thereon, the end of the perforated frame has an outer diameter, and the tuning portion has an outer diameter larger than the outer diameter of the end of the perforated frame.

8. The tunable headphone as recited in claim 1, wherein the tuning frame further includes a tuning sheet sealing at least one opening.
